(19) United States
(12) Patent Application Publication
(10) Pub. No.: US 2024/0417223 A1
(43) Pub. Date: Dec. 19, 2024

(54) FLOATING LIFT

(71) Applicant: Basta IP Inc., SeaTac, WA (US)

(72) Inventor: Nicholas Dashiell LEE, Sea Tac, WA (US)

(21) Appl. No.: 18/667,557

(22) Filed: May 17, 2024

Related U.S. Application Data
(60) Provisional application No. 63/503,287, filed on May 19, 2023.

(51) Int. Cl. B66C 3/06

(52) U.S. Cl. CPC B66C 3/06

(57) ABSTRACT

A floating lift includes a fixed frame, a movable frame, and a platform coupled to the movable frame. A float that may include multiple float sections is coupled to the fixed frame to provide buoyancy to the lift. A lifting assembly is structured to move the movable frame to change a position of the platform relative to the fixed frame over a range of travel between a raised position and a lowered position. A vehicle can be loaded on the lift in the lowered position and elevated to the raised position to avoid damage to the vehicle. The range of travel of the platform is greater than a length of a lifting arm of the movable frame and the lifting assembly includes a locking link to lock the lift in the raised position. The lift may also include a leveling assembly that assists with uniform movement of the movable frame.

### BACKGROUND

### Technical Field

The present disclosure is generally directed to lifts for use in raising and lowering objects and, more particularly, but not exclusively, to floating lift devices, systems, and methods that may be useful for lowering and raising vehicles into and out of water, respectively.

### Description of the Related Art

Certain types of vehicles intended for use in water, such as seaplanes, personal watercraft, and boats, are known to be challenging to store. Traditionally, such vehicles are selectively secured to infrastructure, such as a dock or pier, with ropes and other like devices to prevent the vehicles from floating away when they are not in use. One significant issue with this approach is contamination and growth on the surfaces of the vehicle, such as a boat hull, that are in contact with water. Absent continuous cleaning, the contamination and growth can result in permanent discoloration of the vehicle and potentially even compromise the structural integrity of the vehicle over time, at least to some degree. Even when tied with ropes, wind, currents, storms, and other environmental factors can act on the vehicles and push the vehicles into the infrastructure or cause the vehicles to hit the infrastructure, resulting in damage. In a worst-case scenario, these environmental factors can cause the ropes to become untied or break, such that the vehicles float away from the infrastructure. The vehicles may then strike a foreign object and sink or otherwise suffer significant damage by washing up on shore, among other issues. Such concerns are particularly pronounced for long-term storage (i.e., at least overnight) because the owner is typically not alert to the danger and available to prevent the damage.

In response, certain vehicle lifts, such as boat lifts, have been proposed to selectively lower and raise vehicles into and out of the water depending on whether the vehicle is intended to be used or stored, respectively. At a basic level, boat lifts include a drive system that assists with raising and lowering a platform. The vehicle is positioned on the platform in the water, and the drive system is activated to raise the platform and vehicle out of the water for storage. This process is reversed to lower the platform back into the water when an operator intends to use the vehicle. Despite known vehicle lifts overcoming some of the above issues with traditional rope-based storage of vehicles in water, known vehicle lifts have several deficiencies and drawbacks.

For example, known drive systems for vehicle lifts have issues with balancing and stabilization that can result in creep, or one side of the lift being higher or lower than others during the lowering and raising operations. This can lead to destabilization of the vehicle on the lift. Further, some vehicle lifts rely solely on the drive system to retain the vehicle in the lifted or storage position. Thus, if the drive system fails (i.e., a cable or hydraulic line fails), the lift will unintentionally return to the lowered position and potentially float away. Many known vehicle lifts are also limited in their range of travel between the lowered and raised positions, which can make it difficult to load a vehicle on the lift and fail to prevent damage and other issues from extreme weather and environmental conditions. Most known lift designs also include legs that are intended to contact or be secured to a ground surface or “bottom” of a body of water to secure and stabilize the lift. Such an approach limits the range of applications for the lift, such as to only relatively shallow locations, while also presenting additional challenges with respect to changing underwater conditions and varying water levels. Where floating lift designs have been proposed to remedy such issues, the lifts typically have floats that are prone to rolling or are otherwise unstable in water.

As a result, it would be advantageous to have lift devices, systems, and methods that overcome the above deficiencies and drawbacks of known technology.

### BRIEF SUMMARY

The present disclosure is generally directed to lift devices, systems, and methods and, more specifically, to floating lift, devices, systems, and methods. A floating lift may include a fixed frame that includes vertical supports. One or more floats are attached to the vertical supports to provide buoyancy to the lift. The floats may include multiple float sections joined together by float the assemblies or other structures. The floats have a height that is greater than a width of the floats as well as a tapered outer longitudinal edges to assist with counteracting wave action on the floats and the floating lift, among other advantages described herein.

The lift further includes a movable frame coupled to the fixed frame and a platform coupled to the movable frame. The movable frame is structured to move to change a position of the platform relative to the fixed frame over a range of travel between a raised position and a lowered position. One or more lifting assemblies enables such movement of the movable frame, which may be hydraulic cylinders or actuators in some non-limiting examples. The lifting assembly further includes a bell crank, lifting plates, a lifting tube, and a locking link. The bell crank is coupled to the hydraulic cylinder with the cylinder structured to rotate the bell crank. The bell crank is also rotatably coupled to the movable frame, such that rotation of the bell crank produces rotation of the movable frame relative to the fixed frame. As the movable frame rotates, ends of the frame slide along channels of the fixed frame. The combined rotation and sliding action enables the movement of the platform over the range of travel. In some examples, the bell crank rotates more than 90 degrees, such that the range of travel of the platform in a vertical direction is greater than a length of the lifting arms of the movable frame. This arrangement enables an increase in the range of travel of the platform relative to known techniques, which is advantageous for loading the vehicle on the lift in the lowered position and also for storing the vehicle at a height relative to a water surface that prevents damage from adverse environmental factors.

The lifting plates and lifting tube cooperate with the bell crank to enable movement of the movable frame and also to support the bell crank. The locking link is rotatably coupled to the bell crank and rotatably coupled to the movable frame. When the lift is in the raised position, the locking link is positioned at an angular orientation beyond vertical (i.e., beyond center). In this position, the angular orientation of the locking link relative to vertical tends to bias the locking link, under weight of the vehicle on the lift, to continue rotating toward or beyond the raised position. In other words, the locking link is positioned to prevent rotation of the bell crank to return the platform from the raised position to the lowered position. However, further rotation of the locking link beyond the raised position is prevented by the lifting tube. Accordingly, the locking link assists with holding the lift in the raised position and distributing the weight of the vehicle on the lift to the fixed frame, instead of the vehicle weight being held solely by a hydraulic system of the lift. In the event of failure of the lift or a drive system of the lift, the lift will remain in the raised and locked position as a result of the locking link. Such an arrangement has a number of advantages, including reduced wear and tear on the lift over time and improved safety and peace of mind, among others.

The lift may include multiple lifting assemblies, as well as a leveling assembly. The leveling assembly includes a leveler bar rotatably coupled to the fixed frame and leveler rods coupled between the leveler bar and the movable frame. The leveling assembly assists with counteracting the different forces from the multiple lifting assemblies that act on the movable frame. In other words, if one lifting assembly is providing a different force than the other lifting assemblies, one part of the movable frame may move at a different rate or by a different amount than the remainder of the movable frame and result in instability. The leveler rods push and pull on the leveler bar to distribute force evenly between the lifting assemblies and ensure uniform movement of the movable frame over the range of travel of the platform.

The above summary is non-limiting and additional detail regarding the implementations of the disclosure and advantages achieved by the techniques disclosed herein are provided below.

### BRIEF DESCRIPTION OF THE SEVERAL VIEWS OF THE DRAWINGS

The present disclosure will be more fully understood by reference to the following figures, which are for illustrative purposes only. These non-limiting and non-exhaustive implementations are described with reference to the following drawings, wherein like labels refer to like parts throughout the various views unless otherwise specified. The particular shapes of the elements as drawn may have been selected for ease of recognition in the drawings. The figures do not describe every aspect of the teachings disclosed herein and do not limit the scope of the claims.

FIG. 1 is an isometric view of an implementation of a lift with floats in a raised position according to the present disclosure.

FIGS. 2A-2C are isometric views of the lift of FIG. 1 in the raised position, a transition position, and a lowered position illustrating sequential steps in a lowering operation of the lift.

FIGS. 3A-3C are right side elevational views of the lift of FIGS. 2A-2C illustrating operation of a lifting assembly during the lowering operation of the lift.

FIGS. 4A-4C are cross-sectional views of the lift of FIGS. 2A-2C along lines A-A, B-B, and C-C in FIGS. 2A-2C, respectively, illustrating operation of a leveling assembly during the lowering operation of the lift.

FIG. 5 is a cross-sectional view of the lift of FIG. 2A along line D-D in FIG. 2A illustrating a bell crank support.

FIG. 6A and FIG. 6B are cross-sectional views of the floats of the lift of FIG. 1 along line E-E and line F-F in FIG. 1, respectively.

FIG. 6C is a detail view of area G of FIG. 6B illustrating a float tie assembly.

FIG. 7 is an isometric view of an implementation of a lift in a raised position according to the present disclosure.

FIGS. 8A-8H are various views of an ornamental design of a float according to the present disclosure.

### DETAILED DESCRIPTION

Persons of ordinary skill in the relevant art will understand that the present disclosure is illustrative only and not in any way limiting. Other implementations of the presently disclosed systems and methods readily suggest themselves to such skilled persons having the assistance of this disclosure.

Each of the features and teachings disclosed herein can be utilized separately or in conjunction with other features and teachings to provide lift devices, systems, and methods. Representative examples utilizing many of these additional features and teachings, both separately and in combination, are described in further detail with reference to the attached figures. This detailed description is merely intended to teach a person of skill in the art further details for practicing aspects of the present teachings and is not intended to limit the scope of the claims. Therefore, combinations of features disclosed in the detailed description may not be necessary to practice the teachings in the broadest sense, and are instead taught merely to describe particularly representative examples of the present technology.

Moreover, the various features of the representative examples and the dependent claims may be combined in ways that are not specifically and explicitly enumerated in order to provide additional useful implementations of the present teachings. It is also expressly noted that all value ranges or indications of groups of entities disclose every possible intermediate value or intermediate entity for the purpose of original disclosure, as well as for the purpose of restricting the claimed subject matter. The dimensions and the shapes of the components shown in the figures are designed to help understand how the present teachings are practiced, but are not intended to limit the dimensions and the shapes shown in the examples in some implementations. In some implementations, the dimensions and the shapes of the components shown in the figures are exactly to scale and intended to limit the dimensions and the shapes of the components.

The present disclosure is generally directed to lift devices, systems, and methods that may be particularly advantageous for raising and lowering vehicles. Although the present disclosure will proceed to describe certain non-limiting examples of a floating lift intended for use in water without being secured to an underwater ground surface or “bottom” surface of a body of water, it is to be appreciated that the concepts of the disclosure are not limited solely to floating lifts. Rather, the techniques described herein can be applied equally to any type of lift for use on land or in water. Thus, the disclosure expressly contemplates floating lifts, lifts that are secured to a bottom surface of a body of water, as well as lifts that are intended for use on land, among others. Further, the concepts of the disclosure may be applicable to technology beyond lifting devices, systems, and methods for vehicles, such as any lifting device, system, or method for raising and lowering any type of object. In one non-limiting example, the concepts and technology discussed herein may be particularly beneficial for and can be applied to or incorporated into any type of scissor lift, including, but not limited to, incorporating the locking devices, systems, and methods contemplated herein as locking devices, systems, and methods on a scissor lift. As a result, the disclosure is not limited to the representative examples illustrated in the accompanying figures and the following description. Except as otherwise provided herein, a “body of water” is interpreted to include lakes, rivers, seas, and oceans. Further, a “vehicle” is interpreted to include at least a boat, personal watercraft, sea planes as well as land-based vehicles, such as cars, trucks, buses, motorcycles and the like in implementations where the techniques described herein are utilized on land.

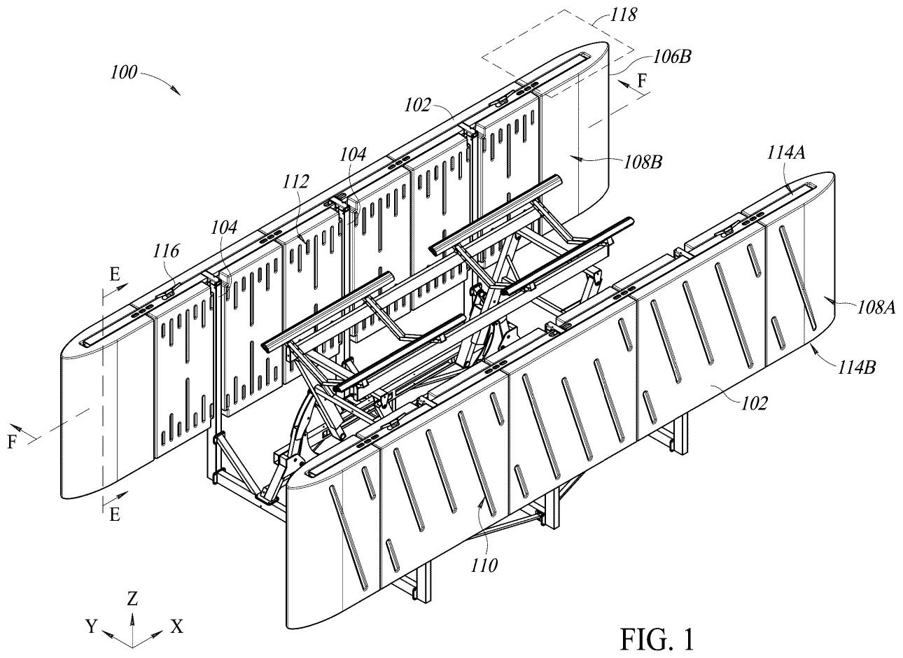

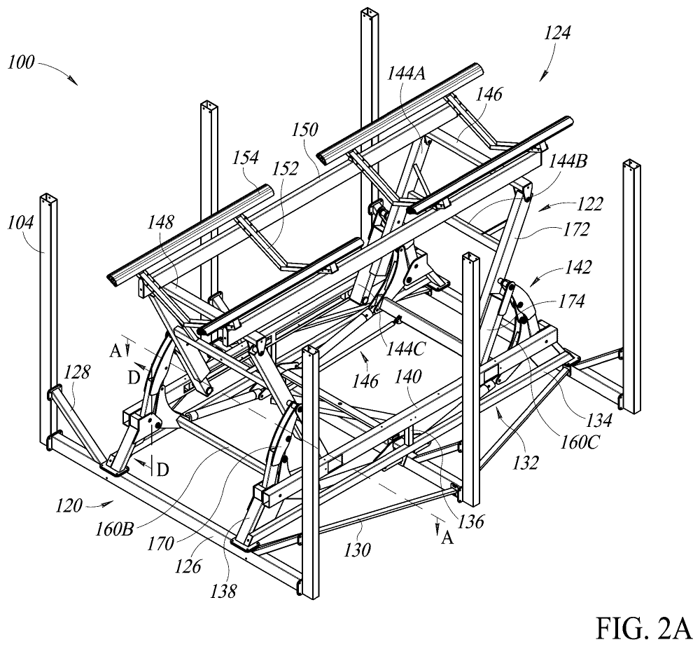

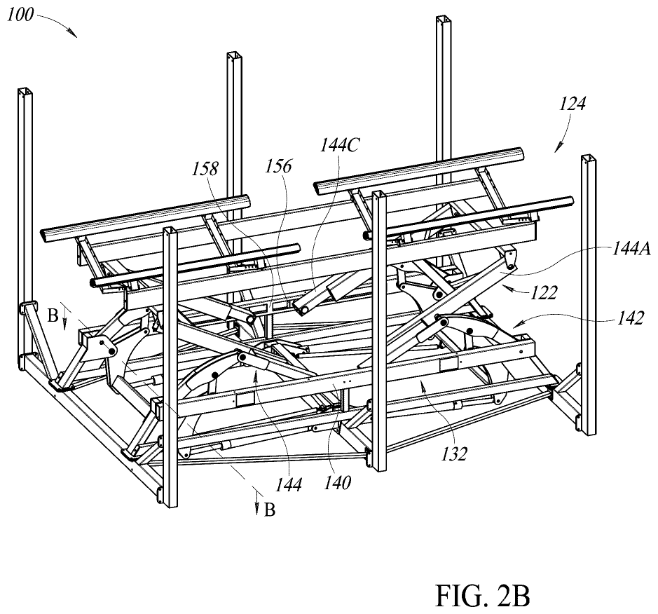

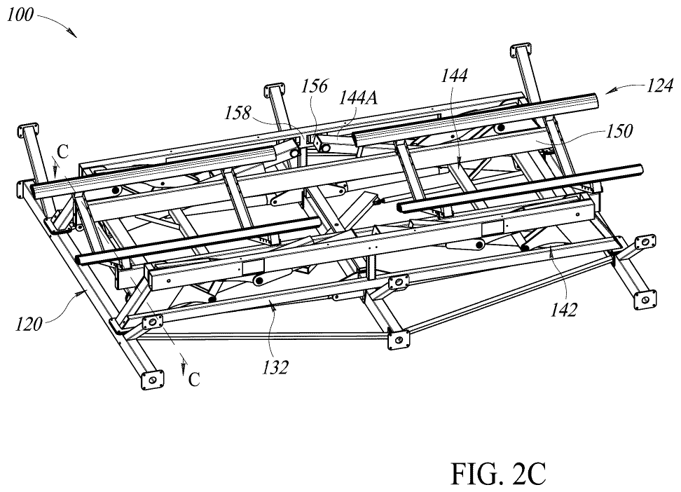

Beginning with FIG. 1, illustrated therein is one or implementations of a lift 100 in a raised position with a plurality of floats 102 coupled to the lift 100. The operation of the lift 100 will be described in more detail with reference to at least FIGS. 2A-5. The floats 102 provide buoyancy to the lift 100 and enable the lift 100 to be positioned floating in water without being directly secured to a bottom surface of the body of water. As a result, the floats 102 enable the lift 100 to be installed in a wide variety of conditions or depths of water. A floating lift is a particular advantage in deeper water, where a lift with legs that are intended to secure to the bottom surface of the body of water are not practical. As will be described below, the lift 100 is also advantageous for use in shallow water, either with floats 102 or optionally with or without legs (not shown) due to the features of the lift. When the lift 100 is installed in water, at least a portion of, a majority of, or an entirety of, each float 102 may be submerged in water, which assists in providing stability to the lift 100, as further described herein.

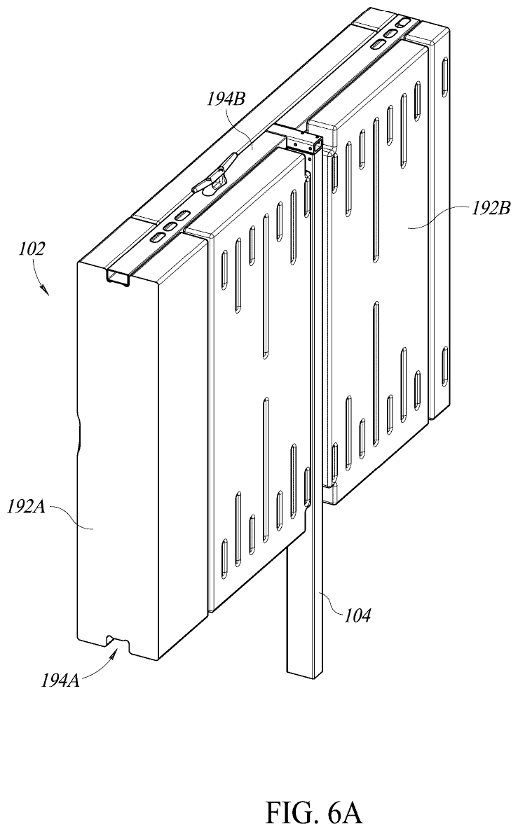

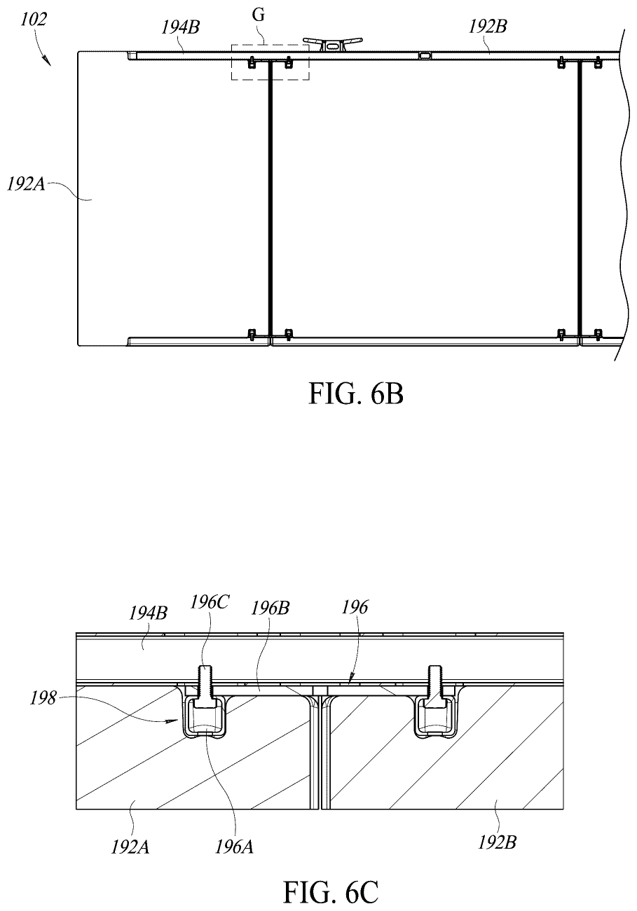

The floats 102 may be coupled to vertical float supports 104 of the lift 100. More details of the connection between the floats 102 and the lift 100, as well as the connection of component parts of the floats 102 to each other is provided with reference to at least FIGS. 6A-6C. In general, the floats 102 may have a first or fore end 106B and a second or aft end 106B opposite to the first end 106B as well as outer and inner surfaces 108A, 108B extending between the first and second ends 106A, 106B. The floats 102 have a length that extends in a longitudinal direction of the lift 100 (i.e., along the X-axis indicated in FIG. 1), a width that extends in a transverse direction of the lift 100 (i.e., a long the Y-axis indicated in FIG. 1), and a height that extends in a lateral direction of the lift 100 (i.e., along the Z-axis indicated in FIG. 1). The length, width, and height of the floats 102 may vary according to the size of the lift 100. In some implementations, the length of the floats 102 is greater than the height of the floats 102, which is greater than the width of the floats 102. In other words, the length may be the largest dimension of the floats 102, followed by the height, and the width being the smallest dimension of the floats 102. While the dimensions of the floats 102 can generally be selected, the floats 102 may be 10 feet, 20 feet, 25 feet or more in length and have a height of around 70 inches (i.e., almost 6 feet). The width may be around 1 foot to 3 feet.

Further, the floats 102 may have a constant cross section across a majority of the length of the floats 102 before tapering or otherwise changing shape at the first and second ends 106A, 106B. The degree and location of the taper has some amount of selection or variation for aesthetic appearances, but the characteristics of the taper also assist with breaking waves that approach the lift 100 and certain degrees and locations of tapers may perform better than others for this purpose. As shown in FIG. 1, the floats 102 have a continuous taper of the outer and inner surfaces 108A, 108B at the first and second ends 106A, 106B that terminates in a rounded or pointed tip at the first and second ends 106A, 106B. The overall design of the floats 102, including the dimensions and the rounded or pointed tip assists with providing buoyancy and stability to the floats 102, among other advantages. In particular, the relatively tall height of the floats 102 assists with increasing the buoyancy of the floats while also increasing the contact surface area of the floats 102 with water to increase stability. The floats 102 are difficult to move in the transverse Y-axis direction, such as from a wave, because the large surface area of the outer and inner surfaces 108A, 108B of the floats 102 increases the resistive force of the water acting on the floats 102 in the transverse direction. The rounded or pointed tip of the floats 102 assists with breaking up or cutting through waves that approach the lift 100 in the longitudinal or X-axis direction to provide further stability.

As noted above, the floats 102 are at least partially, mostly, or entirely, submerged in water at the final installation location. One advantage of this approach and the overall shape and arrangement of the floats 102 is that the floats 102 have minor changes in buoyancy as a result of wave action that increases the stability of the lift 100 in a body of water. More specifically, when there is a certain amount of water level change on the floats 102, such as from wave action, there is a relatively small change in buoyancy of the floats 102 because they are mostly, or entirely, submerged. Thus, instead of the lift 100 and the vehicle on the lift 100 pitching from wave action, the lift 100 and the vehicle stay relatively level with respect to a horizontal plane defined by the water surface absent wave action. The above advantages are particularly pronounced when the lift 100 is installed in a body of water because the lift 100 remains stable despite changes in current, wave action, and other environmental factors. The increased stability reduces the likelihood of the lift 100 and vehicle capsizing.

Other designs for the floats 102 are contemplated herein. For example, the floats 102 may be flat and blunt at the ends 106A, 106B or may have a width that is greater than the height, among many other possibilities. Some floating lifts can also be sensitive to loading and unloading the vehicle because the weight of the vehicle on the lift changes the center of buoyancy. The lift 100 counteracts this instability with the design of the floats 102, and also by the increased range of travel of the lift 100 that enables the vehicle to be loaded and unloaded without distributing significant weight to the lift 100, among other factors.

The floats 102 may also include wave disruption channels 110 in the outer surface 108A of the floats 102 that assist with breaking waves that contact the floats 102, as well as alignment markings 112 that may also be implemented as channels, on the inner surface 108B of the floats 102. The alignment markings 112 may be spaced at regular intervals of a selected measurement system. For example, the alignment markings 112 may be spaced every few inches (i.e., around 3 inches), 6 inches, or one foot apart in some non-limiting examples. The alignment markings 112 assist the user or operator in properly aligning a boat or other vehicle with respect to the lift 100. For example, for a given size of vehicle, the user may be able to determine that the vehicle is positioned properly on the lift 100 if the front end of the vehicle, such as a bow of a boat, is aligned with a certain alignment marking 112 on the inner surface 108B of the floats 102. Many other configurations of the above aspects of the floats 102 are contemplated herein, including without limitation different shapes and arrangements of the floats 102 as well as floats 102 that omit some of the above features.

In some implementations, the floats 102 also include generally flat and planar top and bottom surfaces 114A, 114B. One significant benefit of the floats 102 being flat and planar on the top surface 114A is that additional decking is not required to create a surface for the user to walk on when accessing the vehicle on the lift 100. When the top and bottom surfaces 114A, 114B have similar characteristics (i.e., both being flat and planar, or some other arrangement), the floats 102 are symmetric and can be installed in either orientation for case of assembly. The bottom surface 114B being flat and planar may also be advantageous to assist with reducing roll of the floats 102 in water relative to a curved or angled surface, although the disclosure contemplates the bottom surface 114B being curved, angled, or some other configuration. The top surface 114A being flat and planar enables the floats 102 to support additional structures. For example, cleats 116 can be coupled to the top surface 114A of the floats 102 to assist with securing the lift 110 to external infrastructure, such as a dock, or to enable additional vehicles or boats to be secured to the lift 100. In one or more implementations, a deck 116 may be coupled to the top surface 114A of one or both floats 102 to provide a larger area for a user to stand on while accessing the lift 100 or a vehicle on the lift 100. The deck 116 is represented by a dashed rectangle along part of one of the floats 102 to avoid obscuring the concepts of the disclosure. In some implementations, the deck 116 may extend along a majority or entirety of the length of one or both floats 102, and may have a selected thickness in the lateral or Z-axis direction and selected width in the transverse or Y-axis direction. As can be seen from the above, the floats 102 enable installation and operation of the lift 100 in a variety of depths of water with the design of the floats 102 generally increasing stability relative to prior designs. In some implementations, the floats 102 are omitted in favor of legs that engage with a bottom surface of a body of water, which may be particularly advantageous for implementations of the lift 100 in shallow water.

FIGS. 2A-2C illustrate the lift 100 in the raised position, a transition position, and a lowered position and represent sequential steps in a lowering operation of the lift 100. The lift 100 is illustrated in FIGS. 2A-2C without the floats 102 to avoid obscuring features of the lift 100. The lift 100 generally includes a fixed frame 120, a movable frame 122, and a platform 124. The platform 124 is coupled to the movable frame 122, and the movable frame 122 is coupled to, and support by, the fixed frame 120. In operation, the fixed frame 120 remains stationary, while the movable frame 122 changes position to raise and lower the platform 124, as described further below. The platform 124 may not move, except as otherwise manipulated by the movable frame 122.

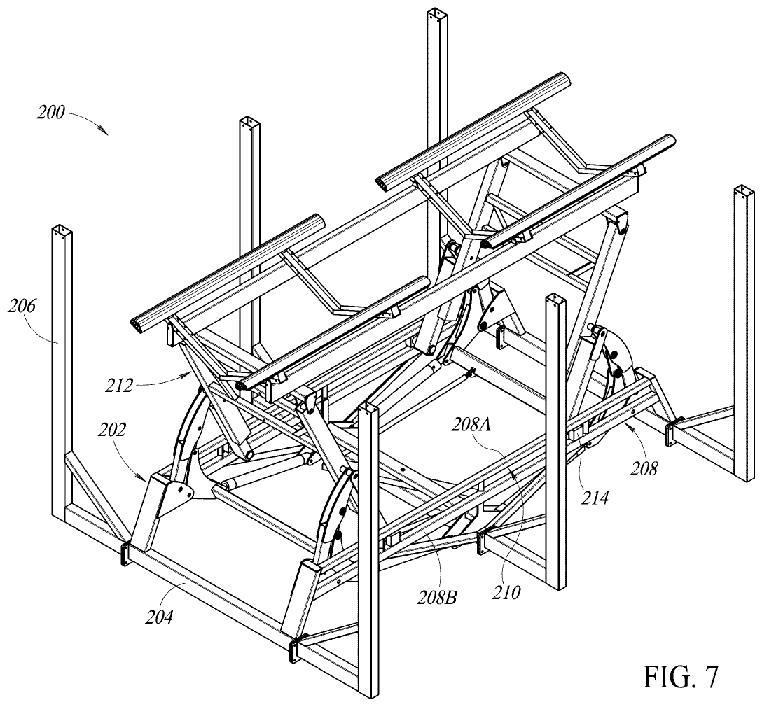

Beginning with FIG. 2A, the fixed frame 120 includes the vertical float supports 104 coupled to a plurality of horizontal cross bars 126 at the bottom of the lift 100. The number of vertical float supports 104 and horizontal cross bars 126 may vary with different sizes or lengths of lifts 100. In the illustrated non-limiting example, the lift 100 includes three cross bars 126 and one pair of vertical float supports 104 associated with each cross bar 126 (i.e., six total vertical float supports 104) with the vertical float supports 104 arranged at opposite ends of each horizontal cross bar 126. Other configurations are considered herein, such as described with reference to FIG. 7. The horizontal cross bar 126 and vertical float support 104 groups are spaced equidistant in the longitudinal (i.e., X-axis direction). In some implementations, the connection between each vertical float support 104 and each cross bar 126 may be further supported by a diagonal brace 128. The diagonal brace 128 may provide additional support for distribution of the weight of the floats 102 (FIG. 1) on the vertical float supports 104. The fixed frame 120 further includes diagonal frame braces 130 that extend between the horizontal cross bars 126 to improve rigidity of the fixed frame 120.

The fixed frame 120 may also include a side frame 132 one each side of the lift 100. The side frames 132 generally extend in the longitudinal direction of the lift 100 on opposite sides of the platform 124 and assist with coupling the movable frame 122 and platform 124 to the fixed frame 120. Each side frame 132 may include a lower bar 134 coupled to the horizontal cross bars 126, one or more side vertical tubes 136 coupled to the lower bar 134, a lifting assembly support 138 coupled to outer ones of the horizontal cross bars 126, and a channel 140 coupled to the lifting assembly supports 138 and the side vertical tube 136.

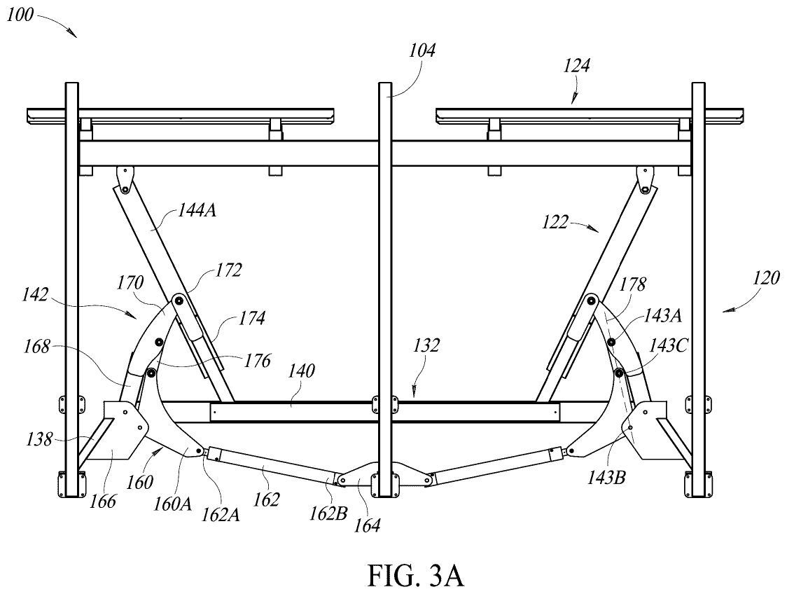

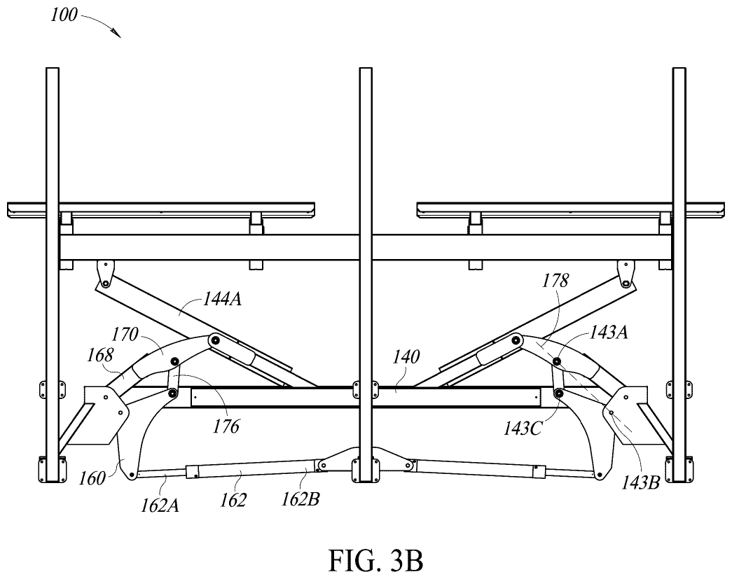

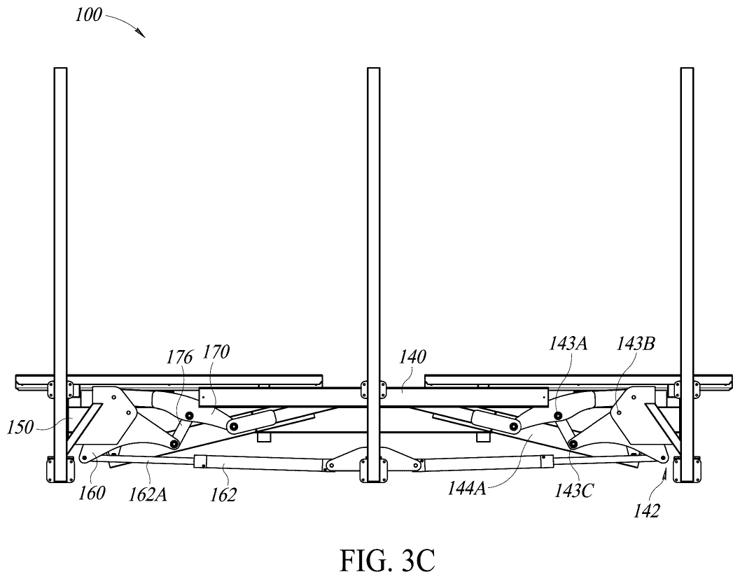

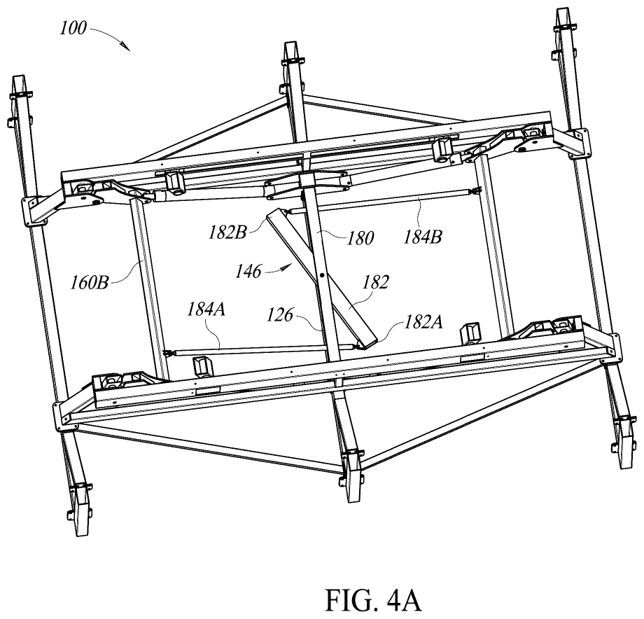

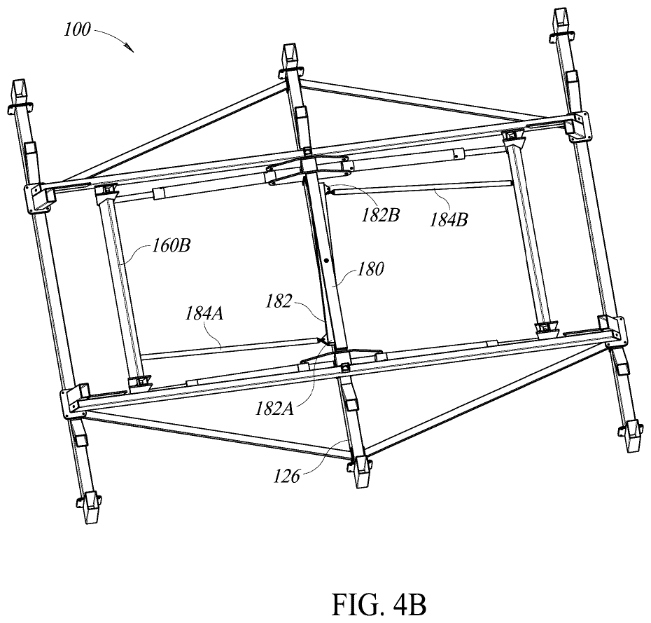

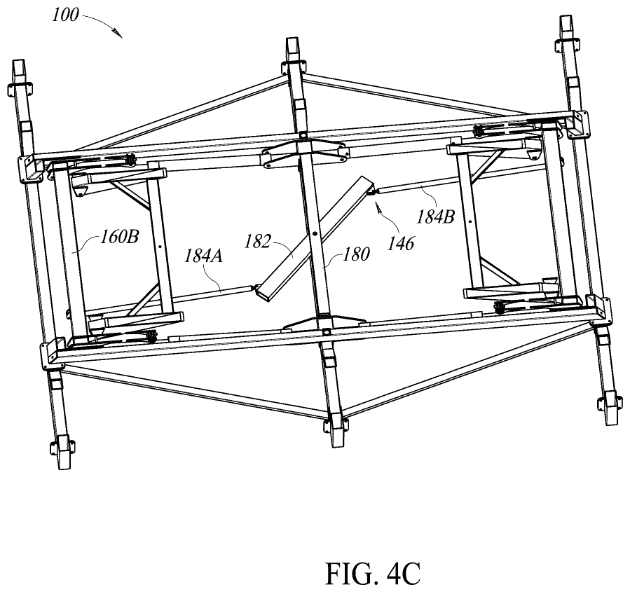

The movable frame 124 includes a plurality of lifting assemblies 142, two H-frames 144, and a leveling assembly 146. The lifting assemblies 142 will be described in more detail with reference to FIGS. 3A-3C and the leveling assembly 146 will be described in more detail with reference to FIGS. 4A-4C. In an implementation, the lift 100 may include four lifting assemblies 142 with one lifting assembly 142 positioned at each opposite longitudinal end of each side frame 132. In other words, one lifting assembly 142 is positioned at each of four corners of a horizontal rectangular plane defined by the side frames 132. The lifting assemblies 142 are operable to raise and lower the H-frames 144 and the platform 124, as described herein. The H-frames 144 include lift arms 144A generally extending in the lateral direction (i.e., Z-axis direction) that are coupled to H-frame cross bars 144B extending in the transverse direction (i.e., Y-axis direction) for rigidity and to resist torsional loads. One lift arm 144A is associated with each lifting assembly 142 in some implementations, although other configurations are contemplated. The H-frames 144 are rotatably coupled to the lifting assemblies 142 and slidably coupled to the channels 140 of the side frames 132. Further, the H-frames 144 are rotatably coupled to the platform 124. In operation, the lifting assemblies 142 rotate the H-frames 144, as described further herein, and ends 144C of the lifting arms 144A of the H-frames 144 slide along the channels 140 of the side frames 132 to change a position of the platform 124 between the raised position of FIG. 2A and the transition and lowered positions shown in FIG. 2B and FIG. 2C, respectively.

The platform 124 includes bunk cross bars 148 extending in the transverse direction that are coupled to the lift arms 144A of the H-frames 144 and bunk rails 150 extending in the longitudinal direction that are coupled to the bunk cross bars 148. The bunk rails 150 support bunk bars 152 with bunk pads 154 coupled to the bunk bars 152. The bunk bars 152 may be arranged in a “V” shape to correspond to the shape of a boat hull in implementations where the lift 100 is a boat lift. The bunk pads 154 cushion and help align the vehicle on the platform 124. Unless the context clearly dictates otherwise, each of the features of the fixed frame 120, movable frame 122, and platform 124 may be coupled to each other with various plates, fasteners, welds or welding techniques, and the like. Further, the lift 100 and its component parts may generally be constructed from suitable materials, such as aluminum, stainless steel, or steel with stainless steel components, in preferred implementations, although other materials are contemplated.

As noted above, FIG. 2A illustrates the lift 100 in the raised position. In some implementations, the raised position in shown in FIG. 2A corresponds to the upper limit of a range of travel of the lift 100. In the raised position, a vehicle, such as a boat, personal watercraft, or seaplane, among others is received in contact with the bunk pads and supported on the platform 124 via the bunk bars 152 and bunk rail 150. The platform 124 is supported in the raised position by the movable frame 122, which is in turn supported by the fixed frame 120. The fixed frame 120 may be attached to floats in implementations where the lift 100 is a floating lift, or some other support structure, such as legs that are intended to contact a ground or bottom surface of a body of water. The raised position generally corresponds to a storage position of the lift 100. In the raised or storage position, the platform 124 and the vehicle on the platform are supported out of the water or above ground where the lift 100 is implemented on land. As described further below, the lift 100 has a range of travel that is greater than a length of the lift arms 144A of the H-frames 144 of the movable frame 122. This range of travel is greater than the range of travel of existing lifts such that the vehicle can be raised further out of the water to prevent damage to the vehicle from extreme weather and other environmental conditions.

In addition, the increased range of travel is beneficial for providing a compact lift that can provide lifting capability within the starting footprint of the lift 100. Conventional lift designs may change the size of their footprint (i.e., at least a portion of the lift extends beyond boundaries of the fixed frame during lifting and lowering), which limits applicability in tight spaces. The features of the lift 100 enable the lift 100 to be installed in tight spaces because the parts of the lift 100 do not extend beyond the footprint of the fixed frame 120 of the lift 100. In addition, the lift 100 has a relatively compact design for the provided range of travel of the platform 124.

Turning to FIG. 2B, the lift 100 is illustrated in a transition position. The transition position may correspond to a mid-span or “middle” position of the range of travel of the lift 100. During operation, the user activates the lifting assemblies 142 to lower the lift 100. More specifically, upon activation, the lifting assemblies 142 act on the lift arms 144A to rotate the H-frames 144 downward toward the side frames 132. As the H-frames 144 rotate, the lower end 144C of each lifting arm 144A slides along the channels 140 of the side frames 132 towards a center of the lift 100 to lower the movable frame 122 and platform 124. The channels 140 may be “C” channels with the lower end 144C of each lift arm 144A rotatably coupled to a corresponding slider or slide plate 156 that moves along the channels 140. Further, the channels 140 may be closed at each end in order to provide structural support to keep the channel 140 from opening under load during operation. As the lower end 144C of the lift arms 144A move along the channels 140 and the lift arms 144A rotate toward the side frames 132, the movable frame 122 and the platform 124 move downwards in the lateral direction (i.e., the Z-axis direction).

The operation of the lift 100 from the transition position in FIG. 2B to the lowered position in FIG. 2C is similar to that described above with respect to operation of the lift 100 from the raised position of FIG. 2A to the lowered position of FIG. 2B. To manipulate the lift 100 to the lowered position, the user continues to activate the lifting assemblies 142 until the lift 100 is in the lowered position shown in FIG. 2C. More specifically, the lifting assemblies 142 continue to move the lift arms 144A of the H-frames 144 toward the fixed frame 120 and the side frames 132 of the fixed frame 120, while the lower ends 144C of the lift arms 144A continue moving along the channels 140 toward a center of the lift 100 via slide plates 156. Movement of the lift 100 beyond the lowered position of FIG. 2C may be prevented by the slide plates 156 contacting a stop 158 at the ends of the channels 140. In an implementation, each channel 140 includes a stop 158 at opposite longitudinal ends (i.e., in the X-axis direction) and a central stop 158. The stops 158 at the longitudinal ends correspond to the raised position and the central stop 158 corresponds to the lowered position. Instead of providing a limit to the range of travel of the platform 124, the stops 158 may preferably be channel supports 158 that provide support for the channel 140, such as to prevent the channel 140 from opening and releasing the slide plate 156 or to prevent the channel 140 from collapsing under the weight of the vehicle on the lift 100 during operation. In such an implementation, the limits to the displacement of the platform 124 are provided by alternative techniques described below. The lowered position illustrated in FIG. 2C may correspond to a lower limit of the range of travel of the lift 100 and may generally be the position at which the lift 100 receives a vehicle. In other words, in the lowered position or in a position near the lowered position, a user can drive a vehicle, such as a boat, onto the lift 100. Once the lift 100 is in the lowered position of FIG. 2C and the vehicle is loaded onto the lift 100, the above steps and processes can generally be repeated in reverse to raise the lift 100 to the raised position of FIG. 2A and elevate the vehicle. In some implementations, the position of the lift 100 is selectable over the range of travel of the lift 100, meaning that a user can move the lift 100 to any position between the raised position and the lowered position.

In a preferred implementation, the range of travel or displacement of the platform 124 is limited in the raised position by the operation of the lifting assemblies 142, and more specifically, a locking link described in more detail below, and in the lowered position by the structure of the lift 100. With continuing reference to FIG. 2C, in the lowered position, the bunk rails 150 of the platform 124 rest on a portion of the fixed frame 120, and more specifically a bell crank tie described further below, to prevent further rotation of the platform 124 beyond the lowered position and possible damage to the lift 100. In the raised position, the locking links described herein prevent further rotation beyond the raised position.

FIGS. 3A-3C provide additional detail of the lifting assemblies 142 during the lowering operation of the lift 100. In FIGS. 3A-3C, certain aspects of the lift 100 are omitted to avoid obstructing details of the lifting assemblies 142. Except as otherwise provided below, each lifting assembly 142 may be identical except for its respective location and orientation in the lift 100. Accordingly, the details of only one lift assembly 142 are provided for brevity.

Beginning with FIG. 3A, and with continuing reference to FIG. 2A, the lifting assemblies 142 may be coupled to the fixed frame 120 and the side frame 132 by a lifting assembly support 138. Each lifting assembly 142 includes a bell crank 160 that may include two bell crank plates 160A spaced from each other in the transverse direction (i.e., the Y-axis direction). The bell crank plates 160A are joined together by a bell crank tie 160B, among other coupling techniques described herein. In an implementation, the bell crank tie 160B extends between two lift assemblies 142 in the transverse direction (i.e., the Y-axis direction) as best shown in FIG. 2A. Thus, there may be a bell crank tie 160B located proximate the front of the lift 100 corresponding to the fore lifting assemblies 142 and a bell crank tie 160B located proximate the rear of the lift 100 corresponding to the aft lifting assemblies 142. In some implementations, the bell crank 160 further includes a reinforcement tube 160C in the space between the bell crank plates 160A and coupled to the bell crank plates 160A to provide additional support and rigidity to the bell crank plates 160A and reduce the likelihood of failure of the bell crank plates 160A under load.

The bell crank ties 160B assist with enabling uniform rotation of the bell crank plates 160A (as well as the bell cranks 160 generally) of separate lifting assemblies 142 at the front and back of the lift 100 to keep the two sides in phase as the lift 100 raises and lowers. While this is advantageous to provide uniform lifting and lowering operations that increase stability, the bell crank ties 160B are not required. In an implementation, the bell crank ties 160B are omitted and rotation of the bell crank plates 160A (as well as the bell crank 160 generally) is controlled by the hydraulic control system described herein. Such a hydraulic control system may monitor and vary pressure using one or more separate hydraulic pumps and associated supply lines to regularly or continuously adjust the hydraulic pressure to the cylinders 162 and enable uniform rotation of the bell cranks 160 without the bell crank ties 160B. Other variations are possible, such as different configurations of mechanical couplings to control rotation of the bell cranks 160 as well as other hydraulic solutions.

A hydraulic cylinder or actuator 162 is coupled to the bell crank 160 and the fixed frame 120. The cylinder 162 includes a rod 162A coupled to the bell crank 160 and a housing 162B coupled to a cylinder mount 164. The cylinder mount 164 is coupled to a central horizontal cross bar 126, as shown in FIG. 2A. In an implementation, the lift 100 is a hydraulically actuated lift because of the advantages provided by hydraulics for lifting applications. In such non-limiting examples, the cylinder 162 is a hydraulic cylinder and the rod 162A is capable of sliding into and out of the housing 162B under the pressure of hydraulic fluid. The hydraulic fluid lines and overall hydraulic fluid control system have not been shown to avoid obscuring the concepts of the disclosure. In sum, the hydraulic fluid control system may be associated with a controller that is manipulatable by a user (either through a remote using various known communication protocols) or through physical switches, among others, that is operable to turn the control system “ON” and “OFF” as well as to activate lifting and lowering operations via the hydraulic fluid control system. When a user activates a lifting or lowering operation via the controller, the hydraulic fluid control system changes a pressure inside the cylinders 162 to either extend or retract the rod 162A, respectively, with respect to the housing 162B. In some implementations, the hydraulic fluid control system and the cylinder 162 are instead replaced with a system of cables, pulleys, and the like for raising and lowering the platform 124. Further details of the operation of the lift 100 are provided below.

The lifting assembly 142 further includes a bell crank support 166 coupled to the bell crank 160 and the lifting assembly support 138. A lifting tube 168 is rotatably coupled to the bell crank support 166 and a pair of lifting plates 170 are coupled to the lifting tube 168. The lifting tube 168 and lifting plates 170 may be separate parts for convenience of manufacturing. In an implementation, these parts may be combined into a single, unitary, continuous structure that replaces the separate lifting tube 168 and lifting plates 170. The lifting plates 170 are spaced from each other in the transverse direction (i.e., Y-axis direction) with one end of each of the plates 170 positioned on outside surfaces of the lifting tube 168, as best shown in FIG. 2A. The other, opposite end of each of the lifting plates 170 is rotatably coupled to a corresponding lifting arm 144A of the moveable frame 122. Each lifting arm 144A may include an upper arm 172 and a lower arm 174 coupled to the upper arm 172, as best shown in FIG. 2A. The lower arm 174 is coupled to the channel 140 and the upper arm 172. The upper arm 172 is coupled to a corresponding H-frame cross bar 144B and the lifting plates 170 are rotatably coupled to the upper arm 172. The number of H-frame cross bars 144B can be selected based on various factors, such as load distribution and the characteristics of each cross bar 144B. Each H-frame 144B may include only one cross bar 144B, or more than one cross bar 144B.

The upper arm 172 may also be positioned closer to a center of the lift 100 in the transverse direction (i.e., Y-axis direction) than the lower arm 174. Thus, the lower arm 174 partially overlaps the upper arm 172 at an interface between the arms 172, 174 of each lifting arm 144A with at least a portion of the upper and lower arms 172, 174 being offset from each other. The offset upper and lower arms 172, 174 of each lifting arm 144A assist with translating the rotary motion of the lifting arm 144A and the sliding of the arm 144A along the channel 140, among other benefits. In some implementations, each lifting arm 144A is instead a single, continuous member directly connected to the lifting plates 170.

Each lifting assembly 142 further includes a locking link 176 rotatably coupled to both the bell crank 160 and the lifting plates 170. The locking link 176 assists with locking each lifting assembly 142 into position once the lift 100 is in the fully raised position to secure the lift 100 in the fully raised position. More specifically, each lifting assembly 142 includes a first pivot 143A at the connection between the lifting plates 170 and the locking link 176 and a second pivot 143B at the connection between the bell crank plates 162A and the bell crank support 166. An axis 178 between these two pivots 143A, 143B may be referred to as a “center” of each lifting assembly 142. Each lifting assembly 142 further includes a third pivot 143C at the connection between the locking link 176 and the bell crank plates 160A. When the third pivot 143C moves beyond center, meaning further from a center of the lift 100 (i.e., the central vertical support 104 in FIG. 3A) than the axis 178, the locking link 176 is biased to rotate toward the center of the lift 100. However, the locking link 176 contacts the lifting tube 168, which prevents further rotation of the locking link 176 and prevents further rotation of the lift 100 beyond the raised position.

Further, in this position, the locking link 176 is positioned at an angular orientation that resists rotation of the lifting assembly 142 to lower the lift 100 to the lowered position. In other words, even if the cylinder 162 were to fail, a bottom of the locking link 176 would tend to rotate toward contact with the lifting tube 168, while a top of the locking link 176 would tend to rotate toward the center of the lift 100 because the locking link 176 is beyond center (or on a side of the axis 178 further from a center of the lift 100). However, the locking link 176 is prevented from further rotation by the lifting tube 168. As a result, the bottom of the link 176 cannot rotate further due to the lifting tube 168, while the top of the link 176 is biased to rotate toward the center of the lift 100, thereby biasing the bottom of the link 176 toward contact with the lifting tube 168 and preventing the top of the locking link 176 from rotating away from the center of the lift and beyond the other side of the axis 178 to the unlocked position. Thus, the lift 100 is considered locked once the locking link 176 is past center (or beyond axis 178 relative to the center of the lift 100) because even in the event of a failure of the lift 100, the locking link 176 prevents the lift 100 from lowering. During the lowering operation, the link 176 is rotated out of the locked position to the other side of the axis 178, as described further below, to enable the lift 100 to transition from the raised position to the lowered position. In the locked position shown in FIG. 3A, the locking link 176 also assists with distributing force from the platform 124, such as a weight of the vehicle on the platform 124, to the fixed frame 120 to reduce the burden on the cylinder 162. Such an arrangement helps reduce wear and tear on the cylinder 162 and improve the durability of the lift 100. The locking link 176 may also provide an audible or tactile response when the link 176 contacts the lifting tube 168 to alert the user that the lift 100 is in the locked position.

In some implementations, the locking link 176 may be omitted and the bell crank 160 and lifting plates 170 may instead be a single, continuous member that is directly connected to the lifting arm 144A. Although not specifically mentioned above, it is to be appreciated that the various connections and rotatable couplings can be accomplished with the use of a variety of different plates, brackets, welds or welding techniques, connectors, bolts, nuts, pins, rods, tubes, and the like. As a non-limiting example, the lifting plates 170 may be attached to the lifting arm 144A with a pivot tube to enable rotary motion of the lifting plates 170 relative to the lifting arm 144A.

Turning to FIG. 3B, illustrated therein is the lifting assembly 142 in the transition position of the lift 100. When a user activates the lift 100 and initiates a lowering operation, the hydraulic fluid control system increases the pressure to the cylinders 162 to extend the rod 162A of each cylinder from the housing 162B. The extension of the rod 162A causes the bell crank 160 to rotate in a clockwise direction about the transverse axis (i.e., clockwise around the Y-axis) which, in turn, rotates the locking link 176 so that the third pivot 143C moves past center (i.e., axis 178) and toward the center of the lift 100. The movement of the third pivot 143C past center (i.e., axis 178) and toward the center of the lift 100 beyond the axis 178 enables the lift 100 to be lowered. The rotation of the bell crank 160 also lowers the lifting tube 168 and lifting plates 170. The movement of the lifting tube 168 and lifting plates 170 lowers the lifting arms 144A as the arms 144A slide along the channel 140.

The above process continues to manipulate the lift 100 from the transition position of FIG. 3B to the lowered position in FIG. 3C. Specifically, the rod 162A of the cylinder 162 continues to extend and causes further rotation of the bell crank 160 and the locking link 176. The further rotation of the bell crank 160 and the locking link 176 results in additional rotation of the lifting tube 168 and lifting plates 170, which move the lifting arm 144A down and cause the lifting arm 144A to slide further along the channel 140 toward the center of the lift 100. From the raised position of FIG. 3A to the lowered position in FIG. 3C, the bell crank 160 may rotate more than 90 degrees clockwise about the transverse axis (i.e., Y-axis). The rotation of the bell crank 160 by more than 90 degrees positions the bunk rails 150 and the bunk tubes 152 (FIG. 2A) of the platform 124 below the channels 140 in the lowered position of the lift 100, which assists with loading vehicles of different sizes and shapes onto the lift. In addition, the bunk rails 150 and bunk tubes 152 being below the channels 140 enables installation of the lift 100 in shallow water either with floats 102 or with or without legs (not shown). In some implementations, a distance from the lower horizontal cross bars 126 at the bottom of the lift 100 to the bottom of the bunk tubes 152 may be less than one foot, or more preferably less than 6 inches, and a distance from the lower horizontal cross bars 126 to the bunk pads may be 24 inches or less, or more preferably about 18 inches or less. As a result, the concepts of the disclosure may enable a lift 100 that can be installed and operated to raise and lower a vehicle in water with a depth of about 18 inches or less in some implementations.

The overall design and operation of the lift 100 also raises and lowers the platform 124 in a vertical direction (i.e., along the Z-axis) without a substantial change in direction of the platform (i.e., less than 5 degrees of change in any axis, or more preferably less than 3 degrees of change in any axis), except for the indicated movement in the vertical direction, in some implementations. Such an arrangement provides stability to the vehicle on the lift and also prevents the vehicle on the lift from changing a center of buoyancy of the floats 102, which avoids pitching, rolling, and other undesirable effects on the floats 102. Further, the movement of the platform 124 without a substantial change in direction other than vertical movement enables the lift 100 to be installed in tighter spaces, such as in a marina where space is limited because the platform 124 and movable frame 122 do not extend beyond the footprint of the fixed frame 120 of the lift 100.

With a typical boatlift design, the range of travel is defined by the movable frame, which typically rotates less than 90 degrees or in some cases about 90 degrees from the lowered position to the raised position. In any event, the range of travel of a conventional design is limited to the length of the movable frame or the length of the lifting arms. The range of travel of the lift 100 is greater than the length of the lifting arms 144A, which increases the range of travel and provides the benefits described herein. As noted above, the lift 100 can also be lowered to a position that assists with loading and unloading vehicles on the platform 124 as a result of the extended range of travel. In some non-limiting examples, the range of travel of the lift 100 may be at least 6 feet to 8 feet, while the lifting arms 144A may be around 5 feet to 6 feet, or less. Many other configurations are possible. To raise the lift 100 from the lowered position to the raised position, the above steps are repeated in reverse.

The extended range of travel of the lift 100 according to the present disclosure is accomplished using multiple techniques. With reference to FIGS. 3A-3C, the range of travel of the platform 124 is defined in part by the rotation of the lifting arms 144A of the H-frame 144 and also the movement and rotation of the components of the lifting assemblies 142, and specifically the bell crank 160. As shown in FIGS. 3A-3C, the lifting assemblies 142 include multiple pivots 143A, 143B, 143C that change position in the vertical or Z-axis direction during the lifting and lowering operations. When the lift 100 is manipulated from the lowered position in FIG. 3C to the raised position in FIG. 3A, the pivots 143A, 143B, 143C are moved to increase the height of the pivots 143A, 143B, 143C relative to a bottommost surface of the lift 100 as a result of the rotation of the components of the lifting assemblies 142 described above. Thus, the range of travel accomplished by the lift 100 is the combination or sum of the length of the lifting arms 144A, which may rotate about 90 degrees, and the change in vertical position of the pivots 143A, 143B, 143C. In some embodiments, the range of travel is also increased by the lifting arms 144A being below horizontal (i.e., below channels 140) in the lowered position. The combination of the above factors enables the lift 100 to have a range of travel of the platform 124 that is greater than a length of the lifting arms 144A, which provides the advantages described herein. In an implementation, the distance between the first and second pivots 143A, 143B increases in the vertical or Z-axis direction until the locking pin 176 is beyond center (or at or on the other side of the axis 178 relative to the center of the lift 100) and then the distance may decrease slightly as the lift 100 reaches the locking position. This slight decrease does not substantially impact the range of travel of the lift 100 and assists with providing the tactile feedback regarding the lift 100 being in the locked position that is noted above.

FIGS. 4A-4C are cross-sectional views of the lift of FIGS. 2A-2C along lines A-A, B-B, and C-C in FIGS. 2A-2C, respectively, providing additional detail of the leveling assembly 146 during the lowering operation of the lift. Beginning with FIG. 4C, the lift 100 may include a support tube 180 coupled to the central horizontal cross bar 126. The leveling assembly 146 includes a leveler bar 182 rotatably coupled to the central horizontal cross bar 126 and the support tube 180. The leveling assembly 146 also includes leveler rods 184A, 184B. The first leveler rod 184A is coupled at one end to a first outer end 182A of the leveler bar 182. The second leveler rod 184B is coupled at one end to a second outer end 182B of the leveler bar 182 with the second outer end 182B being opposite the first outer end 182A. The leveler rods 184A, 184B are pivotably or rotatably coupled at the other end to a respective bell crank tie 160B. The location of the interface or coupling between the leveler rods 184A, 184B and a respective bell crank tie 160B can generally be selected without impacting the functionality of the leveling assembly 146. In a preferred implementation, the leveler rods 184A, 184B are coupled to the respective bell crank tie 160B proximate the bell cranks 160 to reduce deflections in the lift 100.

In operation, the leveling assembly 146 is initially in the position shown in FIG. 4A that corresponds to the raised position of the lift 100 shown, for example, in FIG. 2A and FIG. 3A. The leveling assembly 146 is provided to counteract differences in hydraulic fluid pressure that may occur in a hydraulic fluid system. In a non-limiting example, if one cylinder 162 has a different pressure than another cylinder 162 of the lift 100, the lifting arms 144A may each be moved a different amount or at a different rate, which results in the platform 124 being unbalanced and introduces instability to the vehicle on the platform 124 as well as potential adverse buoyancy effects on the floats 102. The leveling assembly 146 may be optional and omitted in some implementations, in which case, differences in movement of the lifting arms 144A can be compensated for with other mechanical structures or with the hydraulic fluid control system, or both. With reference to FIG. 4B, which corresponds to the transition position of the lift 100 shown at least in FIG. 2B and FIG. 2C, as the lift 100 begins to lower to the transition position, the bell crank ties 160B each move away from the center of the lift 100 (i.e., away from central horizontal cross bar 126) via operation of the lifting assembly 142. The movement of the bell crank ties 160B causes the leveler rods 184A to pull on the opposite ends 182A, 182B of the leveler bar 182 and rotate the leveler bar 182 relative to the support tube 180. The rotation of the first end 182A of the leveler bar 182 pushes against the second leveler rod 184B and the rotation of the second end 182B of the leveler bar 182 pushes against the first leveler rod 184A. This pushing and pulling action helps distribute forces through the leveling assembly 146 and counteract imbalances that may result from one bell crank tie 160B or one side of one bell crank tie 160B moving a lesser distance or at a slower rate than the remaining portions of the bell crank ties 160B.

With reference to FIG. 4C, which corresponds to the lowered position of the lift shown at least in FIG. 2C and FIG. 3C, the continued movement of the lift 100 from the transition position to the lowered position continues the movement of the bell crank ties 160B and thus the rotation of the leveler bar 182 via leveler rods 184A, 184B. Thus, the leveling assembly 146 provides leveling assistance throughout the lowering operation from the raised position to the lowered position, and vice versa as the lift 100 is raised from the lowered position to the raised position. The assistance provided by the leveling assembly 146 assists with counteracting any imbalances in the hydraulic pressure in the cylinders 162 to enable the lift 100 to raise and lower without a substantial change in direction beyond movement in the vertical direction, and also to assist with stabilizing the lift 100 and the vehicle loaded on the lift 100 during the raising and lowering operations. In addition to stabilization, the leveling assembly 146 also assists with avoiding creep and the over center locking and unlocking of the locking link 176 described above. If the arms 144A do not move the same amount or at the same rate, some of the locking links 176 may reach the locked position, while others remain unlocked. The leveling assembly 146 assists with uniform motion of the arms 144A and thus enables consistent locking and unlocking of the lift 100 via the locking links 176.

In an implementation, the leveling assembly 146 enables the cylinders 162 of all four lifting assemblies 142 of the lift 100 to be run from a single pair of hydraulic lines and a single hydraulic pump, which reduces system complexity and cost while also reducing maintenance. In addition, this arrangement prevents hydraulic fluid from moving between ends of opposing cylinders 162 to prevent movement of the lift 100 without input from the hydraulic fluid control system. As noted above, the leveling assembly 100 may be omitted in favor of different mechanical tie designs or a comparatively more complex hydraulic fluid control system that may include multiple pairs of hydraulic lines, one or more pumps, and various monitoring sensors and other like devices to monitor and adjust the hydraulic fluid pressure in each cylinder 162 to enable uniform movement of the platform 124. It is even contemplated that the lift 100 may include less than four independent lifting assemblies 142 in other configurations of the lift 100 in order to overcome the above challenges.

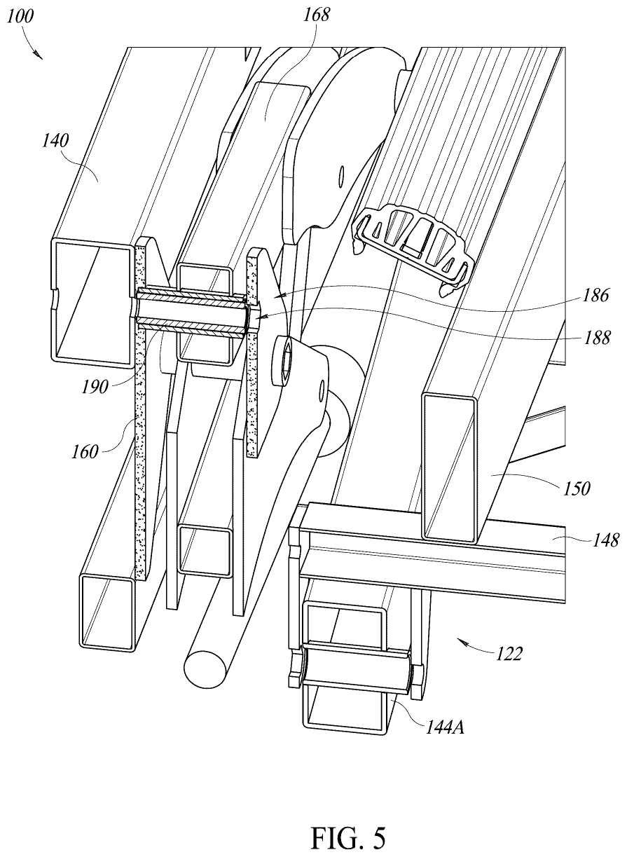

FIG. 5 is a cross-sectional view of the lift 100 along line D-D providing additional detail regarding the bell crank support 160. In FIG. 5, the lift 100 is in the lowered position described herein. To assist with enabling the bunk rails 150 to be positioned below (i.e., in the Z-axis direction) the channels 140 in the lowered position, the bell crank support 160 includes a recessed connection between the bell crank support 160 and the lifting tube 168. As shown in FIG. 5, an inner surface 186 of the bell crank support 160 (i.e., a surface facing toward a center of the lift 100) includes a recess or hole 188 with a pivot tube 190 coupled to the plates of the bell crank support 160 and rotatably coupled to the lifting tube 168. In some implementations, opposite outer ends of the pivot tube 190, and any fasteners or connectors coupled to the pivot tube 190, are recessed with respect to at least the inner surface 186 of the bell crank support 160 to avoid interference between the pivot tube 190 and the movable frame 122, and more specifically between the pivot tube 190 and the bunk cross bars 148. The elimination of this potential interference point enables the bunk rails 150 to be positioned below the channels 140 in the lowered position to increase the range of travel of the lift 100. The pivot tube 190 is a representative, non-limiting example of a device that enables rotational motion according to the present disclosure and may be implemented in other locations in the lift 100 to enable the rotation described herein, among other like devices. In some implementations, the pivot tube 190 includes a bushing, bearing, or other like device to reduce friction and enable smoother rotation.

FIG. 6A and FIG. 6B are cross-sectional views of the floats 102 along line E-E and line F-F in FIG. 1, respectively. FIG. 6C is a detail view of area G of FIG. 6B. Beginning with FIG. 6A and with continuing reference to FIG. 1, the floats 102 may be a rotomolded plastic shell that is filled with a selected foam to increase buoyancy. Many other configurations are possible, including the floats 102 being filled with air or another selected material. Further, the floats 102 may be a single, continuous piece, or may include multiple sections joined together as described herein. In the illustrated implementation of FIG. 1, each float 102 includes five sections with two outer sections 192A including the opposite first and second ends 106A, 106B and three inner sections 192B. Except as otherwise provided, the outer sections 192A may be identical to each other and the inner sections 192B may be identical to each other. The number and arrangement of the sections 192A, 192B of the floats 102 may generally be selected and customizable based on various factors, including at least the size of the lift 100. For example, a longer lift 102 with greater buoyancy to enable a greater lifting capacity may have more than three inner sections 192B in each float 102 and a lift 102 with a smaller length with less buoyancy to enable a lower lifting capacity may have only one or no inner sections 192B in each float 102. In an implementation, the lift 100 may also include more than one float 102 on each side of the lift 100. For example, two floats 102 or more could be attached to each other on both opposite longitudinal sides of the lift 100 using the techniques described herein to further increase the buoyancy and thus the lifting capacity of the lift 100.

The floats 102 may include a track 194A in at least one of, or both, top and bottom surfaces of the floats 102. At the top of the floats 102, the track 194A receives a float cap 194B that may be coupled to the vertical float supports 104, such as with fasteners, to assist with coupling the float sections 192A, 192B to the vertical float supports 104. The track 194A and the float cap 194B are positioned on sides of the floats 102 in an implementation. The float cap 194B may also help with alignment of the float sections 192A, 192B with each other and assist with resisting wave action from separating the float sections 192A, 192B from each other or from the vertical float supports 104, or both. A float cap 194B in the bottom track 194A is optional and may be omitted or included in some implementations. The float cap 194B may also enable connections to additional structures or components, such as at least cleat 116 and deck 118 described with reference to FIG. 1, without damaging or otherwise impacting the floats 102 (i.e., to prevent holes being formed in the floats 102).

Turning to FIG. 6B and FIG. 6C, the floats 102 further include float tie assemblies 196 that assist with coupling the float sections 192A, 192B to each other. The float sections 192A, 192B may include cavities 198 and the float tie assemblies 196 include float tie tubes 196A, a float tie plate 196B, and fasteners 196C. The cavities 198 receive the float tie tubes 196A and the float tie tubes 196A are joined together by the float tie plate 192B and the fasteners 196C. The float tie assemblies may be positioned proximate an interface between the float sections 192A, 192B such that the float tie plate 192B spans the interface between the float sections 192A, 192B and connects the float sections 192A, 192B to each other. In an implementation, the float tie assemblies 196 are positioned in the track 194A at the top and bottom of the lift floats 100 underneath the float cap 194B. The float tie assemblies 196 may also be coupled to the float cap 194B to assist with coupling the float sections 192A, 192B to each other and the vertical float supports 104. A portion of the fasteners 196C may be received in the float cap 194B to enable the float cap 194B to be flush with the top and bottom surfaces of the float sections 192A, 192B and enable the mounting of additional structures to the float cap 194B.

FIG. 7 is an isometric view of an implementation of a lift 200 in a raised position. The lift 200 may be similar to lift 100, except as otherwise provided below. In an implementation, the lift 200 can be a “three in one” lift that can be used as a bottom resting lift (i.e., with or without legs), a lift that can be hung or otherwise secured to a floating dock, permanent pier, or other infrastructure, or can be used with floats, such as floats 102 in a body of water. The lift 200 may be selectively manipulatable between these various configurations. The lift 200 has a fixed frame 202 that includes lower horizontal cross bars 204 coupled to vertical supports 206. With the lift 200, the connection between the horizontal cross bars 204 and vertical supports 206 is located closer to a center of the lift 200. In an implementation, the fixed frame 202 of the lift 200 includes a side frame 208 with the vertical float supports 206 coupled to the fixed frame 202 just beyond or outside of a footprint defined by the side frame 208 on opposite longitudinal sides of the lift 200. In lift 100, the cross bars 126 extend beyond the foot print defined by the side frame 132 and channel 140. In addition, the frame braces 130 (FIG. 2A) are omitted from the lift 200.

The vertical float supports 206 are coupleable to the fixed frame 202 with fasteners or using other like devices and techniques. Thus, the float supports 206 can selectively be removed when the lift 200 is intended for use without floats, such as when the lift 200 is secured to legs or resting on the bottom without legs, or when the lift 200 is secured to existing infrastructure. The float supports 206 can be attached to the lift 200 and secured to floats, such as floats 102 described herein, when the lift 200 is intended for use in a body of water or in a floating configuration. In addition, the location of the connection between the vertical float supports 206 and the fixed frame 202 being closer to the center of the lift 200 enables spacers or other width adjustment devices, which may be tubes or frame elements, to be installed between the cross bars 204 and the float supports 206 to selectively vary a width of the lift 200 and accommodate a variety of different vehicles with different widths and other characteristics.

The lift 200 further omits the channels 140 of the side frame 132 of the lift 100 in favor of the side frame 208 being open on both longitudinal sides. In other words, the side frame 208 includes upper and lower frame elements 208A, 208B, respectively that are spaced from each other in a vertical direction to define a track 210 that is bounded at the top and bottom by the upper and lower frame elements 208A, 208B of the side frame 208, but open on both opposite longitudinal sides. A movable frame 212 of the lift 200 is coupled to sliders 214. The movable frame 212 and the sliders 214 may otherwise be similar to the movable frame 122, the channel 140, and the slide plate 156 of the lift 100 described herein. As the movable frame 212 changes positions, the sliders 214 move along the track 210. The side frame 208 being open on both longitudinal sides prevents marine growth or debris from clogging the channels or otherwise interfering with the travel of the sliders 214 along the side frame 208. Other configurations of the sliders 214 are contemplated herein. For example, the sliders 214 may be associated with devices to reduce friction, such as ball bearings or others, or the upper and lower frame elements 208A, 208B may have a channel or track in the element 208A, 208B that receives a correspondingly shaped protrusion on the sliders 214 to further assist with guiding the sliders 214 along the track 210. A channel with openings to prevent marine growth or debris from lodging in the channel may also be a potential solution, among others.

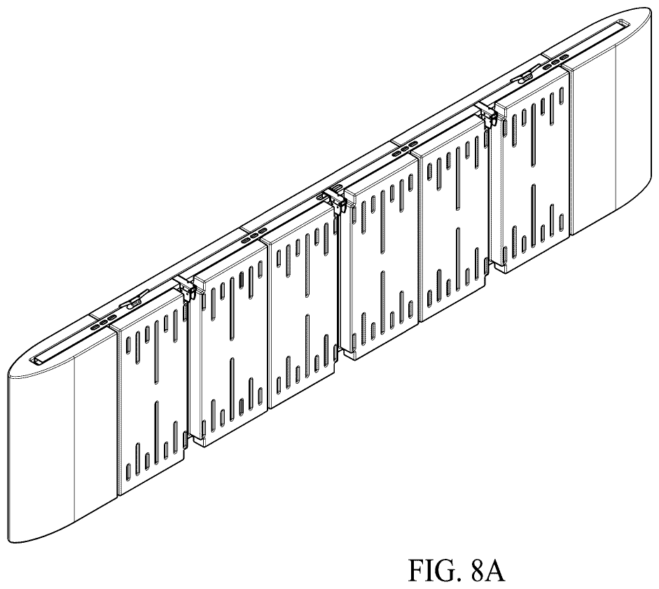

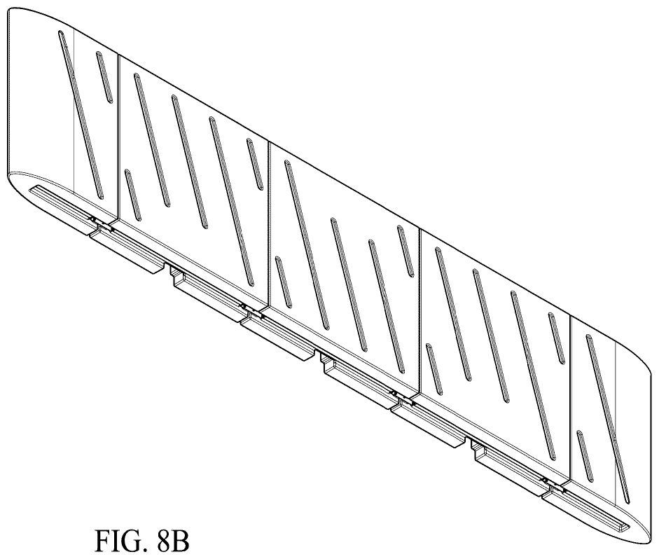

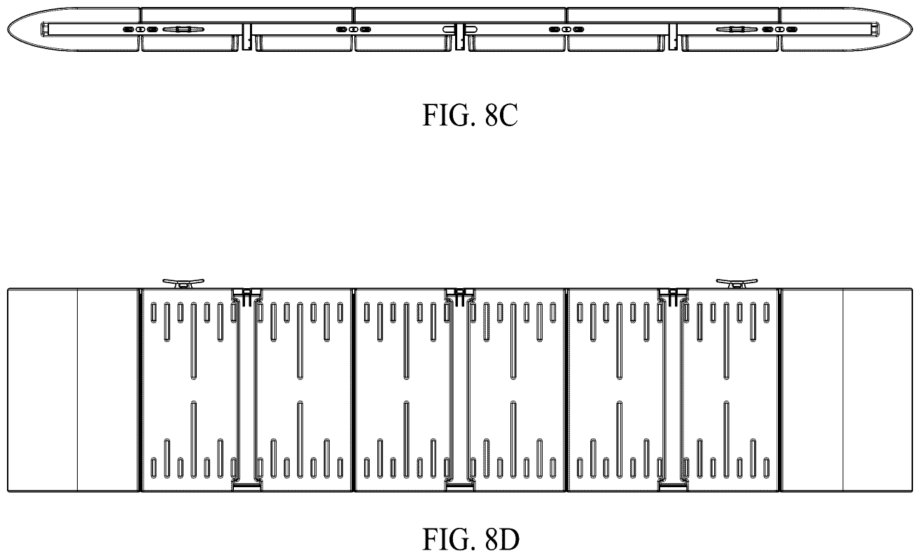

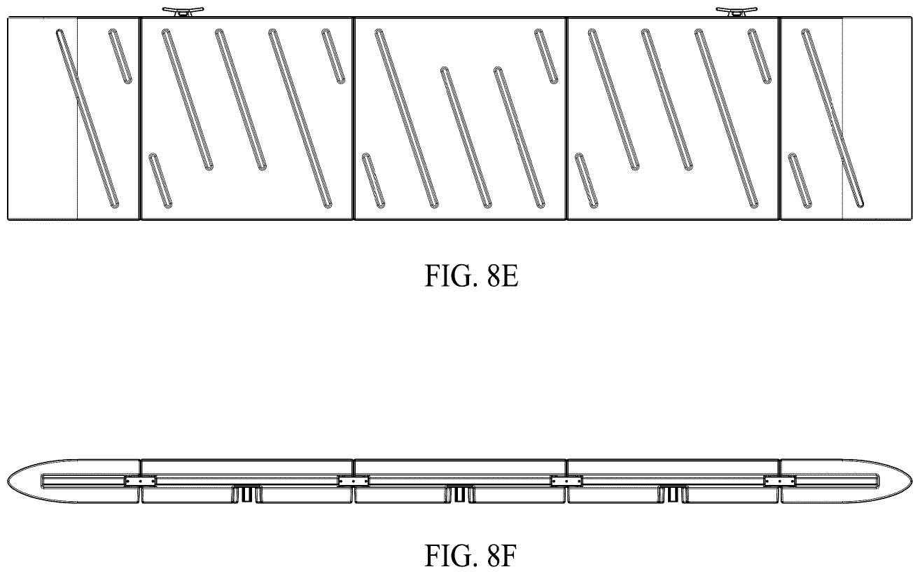

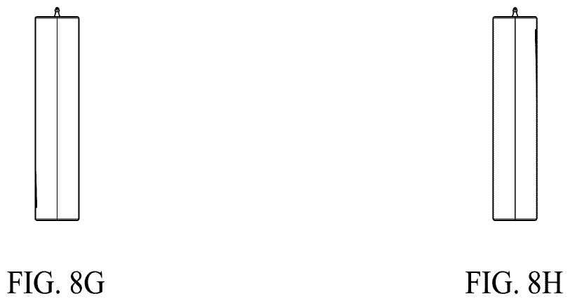

The present disclosure also contemplates the ornamental features of various aspects of the lift 100. For example, FIGS. 8A-8H illustrate the ornamental features of an implementation of the floats 102 and form part of the disclosure. The ornamental features include, but are not limited to: the overall shape and arrangement of the floats 102, such as the width, height, and length; the location and characteristics of the markings on the outer and inner surfaces of the floats; the location and characteristics of the ends of the floats, including the characteristics of the tapered ends, and others.

Although not specifically described herein, the present disclosure also contemplates related methods of operation and manufacturing the lift 100 described herein. In some non-limiting examples, contemplated methods may include methods of raising and lowering the platform 124 according to the techniques described herein as well as methods of manufacturing and assembling the lift 100, among others.

In view of the above, one or more implementations of a system according to the present disclosure may be summarized as including: a fixed frame; a movable frame coupled to the fixed frame, the movable frame including a lifting arm; a platform coupled to the lifting arm of the movable frame, wherein the movable frame is structured to move relative to the fixed frame to change a position of the platform relative to the fixed frame, and wherein a range of travel of the platform between a raised position and a lowered position is greater than a length of the lifting arm of the movable frame.

The system may further include the fixed frame including a channel and a lifting assembly coupled to the fixed frame and the lifting arm of the movable frame, the lifting assembly structured to rotate the lifting arm, wherein the lifting arm is structured to slide along the channel of the fixed frame in response to rotation of the lifting arm to change the position of the platform relative to the fixed frame.

The system may further include a lifting assembly including a hydraulic cylinder and a bell crank, the hydraulic cylinder coupled to the fixed frame and the bell crank rotatably coupled to the hydraulic cylinder, the bell crank further rotatably coupled to the lifting arm of the movable frame, wherein the hydraulic cylinder is structured to rotate the bell crank and, in response to rotation of the bell crank, the bell crank is structured to move the lifting arm. The system may further include the lifting assembly includes a locking link rotatably coupled to the bell crank, wherein the bell crank is structured to rotate the locking link past center in the raised position of the platform to assist, at least in part, with holding the platform in the raised position. The system may further include the center corresponding to a vertical axis through the bell crank.

The system may further include the platform being structured to move over the range of travel in a substantially vertical direction without a substantial change in direction.

The system may further include a float coupled to the fixed frame.

The system may further include the float including a plurality of float sections coupled together by at least one of a float tie assembly and a float cap.

The system may further include a deck coupled to the float.

The system may further include an inner surface of the float including alignment markings.

One or more implementations of a system may be summarized as including: a fixed frame; a movable frame coupled to the fixed frame; a platform coupled to the movable frame; and a float coupled to the vertical support of the fixed frame, the float having a height that is greater than a width of the float.

The system may further include the float further including two float sections coupled to each other with a float tie assembly.

The system may further include the float tie assembly extending across an interface between the two float sections.

The system may further include the float further including a track and a float cap received in the track, the float cap coupled to the vertical support of the fixed frame.

The system may further include a deck coupled to the float cap.

The system may further include the fixed frame including a channel and the movable frame including at least one H-frame, and a lifting assembly coupled to the at least one H-frame and structured to rotate the at least one H-frame, the H-frame structured to slide along the channel of the fixed frame in response to the rotation to change a position of the platform relative to the fixed frame over a range of travel from a raised position to a lowered position.

The system may further include the range of travel of the platform relative to the fixed frame being at least 5 feet.

The system may further include the platform including bunk rails and bunk pads coupled to the bunk rails to receive a vehicle, and wherein in the lowered position, the bunk rails are positioned at least partially below the channel of the fixed frame.

The system may further include a lifting assembly structured to move the movable frame to change a position of the platform relative to the fixed frame, wherein the lifting assembly includes a hydraulic cylinder and a bell crank, the hydraulic cylinder coupled to the fixed frame and the bell crank and structured to rotate the bell crank, wherein the bell crank is rotatably coupled to both the hydraulic cylinder and the H-frame, and the bell crank is structured to move the H-frame in response to rotation of the bell crank via the hydraulic cylinder.

The system may further include the lifting assembly further including a locking link, lifting plates, and a lifting tube, wherein the locking link is rotatably coupled to both the bell crank and the lifting plates, the lifting plates are coupled to the lifting tube and rotatably coupled to the H-frame, and the lifting tube is rotatably coupled to the fixed frame, wherein the lifting assembly has a center position defined by an axis through a connection between the hydraulic cylinder and the bell crank and through a connection between the lifting plates and the locking link, and wherein the locking link is positioned past the center position in the raised position of the platform and prevented from further movement by the lifting tube to lock the platform in the raised position.

One or more implementations of a system may be summarized as including: a fixed frame; a movable frame coupled to the fixed frame, the movable frame including a lifting arm; a platform coupled to the lifting arm of the movable frame; a lifting assembly coupled to the fixed frame and to the lifting arm of the movable frame, the lifting assembly including a hydraulic cylinder, a bell crank, and a locking link, wherein the hydraulic cylinder is structured to rotate the bell crank to change a position of the lifting arm of the movable frame and move the platform relative to the fixed frame over a range of travel between a raised position and a lowered position, and wherein the locking link rotates past center in the raised position to lock the platform in the raised position.

The system may further include the fixed frame further including a vertical support and a float coupled to the vertical support.

The system may further include the float including a plurality of float sections coupled to each other with float tie assemblies.

The system may further include the lifting assembly further including a lifting tube structured to prevent further rotation of the locking link in the raised position.

The system may further include the bell crank structured to rotate more than 90 degrees over the range of travel of the platform.

The system may further include the range of travel of the platform being greater than a length of the lifting arm as a result of the rotation of the bell crank.

The system may further include a leveling assembly including a leveler bar rotatably coupled to the fixed frame and at least one leveler rod coupled to the bell crank, wherein the leveling assembly is structured to balance movement of the movable frame over the range of travel of the platform.

One or more implementations of a system may be summarized as including: a fixed frame; a movable frame coupled to the fixed frame, the movable frame including a first lifting arm and a second lifting arm; a platform coupled to the first lifting arm and the second lifting arm of the movable frame; a first lifting assembly coupled to the fixed frame and to the first lifting arm; a second lifting assembly coupled to the fixed frame and to the second lifting arm, wherein the first lifting assembly and second lifting assembly are structured to move the first lifting arm and second lifting arm to change a position of the platform relative to the fixed frame over a range of travel from a raised position to a lowered position; and a leveling assembly including a leveler bar rotatably coupled to the fixed frame, a first leveler rod coupled to the leveler bar and the first lifting arm, and a second leveler rod coupled to the leveler bar and the second lifting arm, wherein the first leveler rod and second leveler rod are structured to push or pull on the leveler bar in response to movement of the first lifting and the second lifting arm to create uniform movement of the first lifting arm and the second lifting arm in response to different forces exerted on the first lifting arm and the second lifting arm by the first lifting assembly and the second lifting assembly.

The system may further include the first leveler rod and the second leveler rod being coupled to opposite ends of the leveler bar.

The system may further include the fixed frame including a central horizontal support, the leveler bar rotatably coupled to the central horizontal support.

The system may further include the fixed frame including a side frame proximate a bottom of the fixed frame, and wherein at least a portion of the platform is positioned below at least a portion of the side frame in the lowered position.

The system may further include the first lifting arm being part of a first H-frame of the movable frame and the second lifting arm being part of a second H-frame of the movable frame, the first H-frame and second H-frame positioned on opposite longitudinal sides of the movable frame.

The system may further include the first leveler rod being coupled to a first horizontal support associated with the first lifting assembly and the second leveler rod being coupled to a second horizontal support associated with the second lifting assembly, and wherein the leveling assembly is structured to offset different hydraulic pressures in the first lifting assembly and the second lifting assembly.

One or more implementations of a system may be summarized as including a floating lift with a range of travel greater than a length of a lifting arm of the floating lift.

One or more implementations of a system may be summarized as including a lift configured to raise and lower an object, the lift further configured to be selectively secured to any one of: one or more floats, a floating dock or floating structure, or a bottom surface of a body of water.

One or more implementations of a method are contemplated according to any of the above non-limiting examples of implementations of the disclosure.

The above description of illustrated implementations, including what is described in the Abstract, is not intended to be exhaustive or to limit the implementations to the precise forms disclosed. Although specific implementations of and examples are described herein for illustrative purposes, various equivalent modifications can be made without departing from the spirit and scope of the disclosure, as will be recognized by those skilled in the relevant art. The teachings provided herein of the various implementations can be applied outside of the lift or floating lift context, and are not limited to the example lift devices, systems, methods, and devices generally described above.

Many of the methods described herein can be performed with variations. For example, many of the methods may include additional acts, omit some acts, and/or perform acts in a different order than as illustrated or described.

In the above description, certain specific details are set forth in order to provide a thorough understanding of various implementations of the disclosure. However, one skilled in the art will understand that the disclosure may be practiced without these specific details. In other instances, well-known structures associated with lift devices, systems, and methods have not been described in detail to avoid unnecessarily obscuring the descriptions of the implementations of the present disclosure.

Certain words and phrases used in the specification are set forth as follows. As used throughout this document, including the claims, the singular form “a”, “an”, and “the” include plural references unless indicated otherwise. Any of the features and elements described herein may be singular, e.g., a lift may refer to one lift. The terms “include” and “comprise,” as well as derivatives thereof, mean inclusion without limitation. The phrases “associated with” and “associated therewith,” as well as derivatives thereof, may mean to include, be included within, interconnect with, contain, be contained within, connect to or with, couple to or with, be communicable with, cooperate with, interleave, juxtapose, be proximate to, be bound to or with, have, have a property of, or the like. Other definitions of certain words and phrases are provided throughout this disclosure.

The use of ordinals such as first, second, third, etc., does not necessarily imply a ranked sense of order, but rather may only distinguish between multiple instances of an act or a similar structure or material.

Throughout the specification, claims, and drawings, the following terms take the meaning explicitly associated herein, unless the context clearly dictates otherwise. The term “herein” refers to the specification, claims, and drawings associated with the current application. The phrases “in one implementation,” “in another implementation,” “in various implementations,” “in some implementations,” “in other implementations,” and other derivatives thereof refer to one or more features, structures, functions, limitations, or characteristics of the present disclosure, and are not limited to the same or different implementations unless the context clearly dictates otherwise. As used herein, the term “or” is an inclusive “or” operator, and is equivalent to the phrases “A or B, or both” or “A or B or C, or any combination thereof,” and lists with additional elements are similarly treated.

Generally, unless otherwise indicated, the materials for making the invention and/or its components may be selected from appropriate materials such as composite materials, ceramics, plastics, metal, polymers, thermoplastics, elastomers, plastic compounds, and the like, either alone or in any combination.

The foregoing description, for purposes of explanation, uses specific nomenclature and formula to provide a thorough understanding of the disclosed implementations. It should be apparent to those of skill in the art that the specific details are not required in order to practice the invention. The implementations have been chosen and described to best explain the principles of the disclosed implementations and its practical application, thereby enabling others of skill in the art to utilize the disclosed implementations, and various implementations with various modifications as are suited to the particular use contemplated. Thus, the foregoing disclosure is not intended to be exhaustive or to limit the invention to the precise forms disclosed, and those of skill in the art recognize that many modifications and variations are possible in view of the above teachings.

The terms “top,” “bottom,” “upper,” “lower,” “up,” “down,” “above,” “below,” “left,” “right,” and other like derivatives take their common meaning as directions or positional indicators, such as, for example, gravity pulls objects down and left refers to a direction that is to the west when facing north in a Cardinal direction scheme. These terms are not limiting with respect to the possible orientations explicitly disclosed, implicitly disclosed, or inherently disclosed in the present disclosure and unless the context clearly dictates otherwise, any of the aspects of the implementations of the disclosure can be arranged in any orientation.

As used herein, the term “substantially” is construed to include an ordinary error range or manufacturing tolerance due to slight differences and variations in manufacturing. Unless the context clearly dictates otherwise, relative terms such as “approximately,” “substantially,” and other derivatives, when used to describe a value, amount, quantity, or dimension, generally refer to a value, amount, quantity, or dimension that is within plus or minus 5% of the stated value, amount, quantity, or dimension. It is to be further understood that any specific dimensions of components or features provided herein are for illustrative purposes only with reference to the various implementations described herein, and as such, it is expressly contemplated in the present disclosure to include dimensions that are more or less than the dimensions stated, unless the context clearly dictates otherwise.

The present application claims priority to U.S. Provisional Patent Application No. 63/503,287 filed on May 19, 2023, the entire contents of which are incorporated herein by reference.

These and other changes can be made to the implementations in light of the above-detailed description. In general, in the following claims, the terms used should not be construed to limit the claims to the specific implementations disclosed in the specification and the claims, but should be construed to include all possible implementations along with the full scope of equivalents to which such claims are entitled. Accordingly, the breadth and scope of a disclosed implementation should not be limited by any of the above-described implementations, but should be defined only in accordance with the following claims and their equivalents.

1. A system, comprising:
a fixed frame;
a movable frame coupled to the fixed frame, the movable frame including a lifting arm;
a platform coupled to the lifting arm of the movable frame,
wherein the movable frame is structured to move relative to the fixed frame to change a position of the platform relative to the fixed frame, and
wherein a range of travel of the platform between a raised position and a lowered position is greater than a length of the lifting arm of the movable frame.

2. The system of claim 1, wherein the fixed frame includes a channel, the system further comprising:
a lifting assembly coupled to the fixed frame and the lifting arm of the movable frame, the lifting assembly structured to rotate the lifting arm,
wherein the lifting arm is structured to slide along the channel of the fixed frame in response to rotation of the lifting arm to change the position of the platform relative to the fixed frame.

3. The system of claim 1, further comprising:
a lifting assembly including a hydraulic cylinder and a bell crank, the hydraulic cylinder coupled to the fixed frame and the bell crank rotatably coupled to the hydraulic cylinder, the bell crank further rotatably coupled to the lifting arm of the movable frame,
wherein the hydraulic cylinder is structured to rotate the bell crank, and, in response to rotation of the bell crank, the bell crank is structured to move the lifting arm.

4. The system of claim 3, wherein the lifting assembly includes a locking link rotatably coupled to the bell crank, wherein the bell crank is structured to rotate the locking link past center in the raised position of the platform to assist, at least in part, with holding the platform in the raised position.

5. The system of claim 4, wherein the center corresponds to a vertical axis through the bell crank.

6. (canceled)

7. The system of claim 1, further comprising:
a float system coupled to the fixed frame.

8. The system of claim 7, wherein the float system includes a float having a height that is greater than a width of the float.

9-20. (canceled)

21. A system, comprising:
a fixed frame;
a movable frame coupled to the fixed frame, the movable frame including a lifting arm;
a platform coupled to the lifting arm of the movable frame;
a lifting assembly coupled to the fixed frame and to the lifting arm of the movable frame, the lifting assembly including a hydraulic cylinder, a bell crank, and a locking link,
wherein the hydraulic cylinder is structured to rotate the bell crank to change a position of the lifting arm of the movable frame and move the platform relative to the fixed frame over a range of travel between a raised position and a lowered position, and
wherein the locking link rotates past center in the raised position to lock the platform in the raised position.

22. The system of claim 21, further comprising:
a float coupled to the fixed frame.

23. The system of claim 22, wherein the float has a height that is greater than a width of the float.

24. The system of claim 21, wherein the lifting assembly further includes a lifting tube structured to prevent further rotation of the locking link in the raised position.

25. The system of claim 21, wherein the bell crank is structured to rotate more than 90 degrees over the range of travel of the platform.

26. The system of claim 25, wherein the range of travel of the platform is greater than a length of the lifting arm as a result of the rotation of the bell crank.

27. The system of claim 21 further comprising:
a leveling assembly including a leveler bar rotatably coupled to the fixed frame and at least one leveler rod coupled to the bell crank, wherein the leveling assembly is structured to balance movement of the movable frame over the range of travel of the platform.

28. A system, comprising:
a fixed frame;
a movable frame coupled to the fixed frame, the movable frame including a first lifting arm and a second lifting arm;
a platform coupled to the first lifting arm and the second lifting arm of the movable frame;
a first lifting assembly coupled to the fixed frame and to the first lifting arm;
a second lifting assembly coupled to the fixed frame and to the second lifting arm, wherein the first lifting assembly and second lifting assembly are structured to move the first lifting arm and second lifting arm to change a position of the platform relative to the fixed frame over a range of travel from a raised position to a lowered position; and
a leveling assembly including a leveler bar rotatably coupled to the fixed frame, a first leveler rod coupled to the leveler bar and the first lifting arm, and a second leveler rod coupled to the leveler bar and the second lifting arm,
wherein the first leveler rod and second leveler rod are structured to push or pull on the leveler bar in response to movement of the first lifting and the second lifting arm to create uniform movement of the first lifting arm and the second lifting arm in response to different forces exerted on the first lifting arm and the second lifting arm by the first lifting assembly and the second lifting assembly.

29. The system of claim 28, wherein the first leveler rod and the second leveler rod are coupled to opposite ends of the leveler bar.

30. The system of claim 28, further comprising:
a float coupled to the fixed frame, wherein the float has a height that is greater than a width of the float.

31. The system of claim 28, wherein the fixed frame includes a side frame proximate a bottom of the fixed frame, and
wherein at least a portion of the platform is positioned below at least a portion of the side frame in the lowered position.

32. The system of claim 28, wherein the first lifting arm is part of a first H-frame of the movable frame and the second lifting arm is part of a second H-frame of the movable frame, the first H-frame and second H-frame positioned on opposite longitudinal sides of the movable frame.

33. The system of claim 32, wherein the first leveler rod is coupled to a first horizontal support associated with the first lifting assembly and the second leveler rod is coupled to a second horizontal support associated with the second lifting assembly, and
wherein the leveling assembly is structured to offset different hydraulic pressures in the first lifting assembly and the second lifting assembly.

34-36. (canceled)
